(19) United States
(12) Patent Application Publication
(10) Pub. No.: US 2015/0183280 A1
(43) Pub. Date: Jul. 2, 2015

(54) METHOD, APPARATUS AND SYSTEM FOR INDICATING THE LOCATION OF A TIRE IN AN ABNORMAL CONDITION USING AT LEAST ONE VEHICLE TURN SIGNAL

(71) Applicant: Continental Automotive Systems, Inc., Auburn Hills, MI (US)

(72) Inventors: Matthew D. McIntyre, New Baltimore, MI (US); Jean-Christophe Deniau, Fenton, MI (US); Brian Farrell, Troy, MI (US)

(21) Appl. No.: 14/144,956

(22) Filed: Dec. 31, 2013

(51) Int. Cl. B60C 23/04

(52) U.S. Cl. CPC B60C 23/0486

(57) ABSTRACT

A method, apparatus and system for indicating the location of a tire in an abnormal condition using at least one vehicle turn signal are disclosed. The method comprises determining whether at least one tire is in an abnormal condition, determining the location of the tire in abnormal condition, and indicating the location of at least one tire in abnormal condition using at least one vehicle turn signal.

### BRIEF DESCRIPTION OF THE DRAWINGS

For a more complete understanding of the disclosure, reference should be made to the following detailed description and accompanying drawings wherein:

FIG. 1 comprises a schematic pictorial view of an exemplary abnormal tire condition indication with one tire in abnormal condition;

FIG. 2 comprises a schematic pictorial view of an exemplary abnormal tire condition indication with two tires in abnormal condition.

Skilled artisans will appreciate that elements in the figures are illustrated for simplicity and clarity and have not necessarily been drawn to scale. For example, the size dimensions and/or relative positioning of some of the elements in the figures may be exaggerated relative to other elements to help to improve understanding of various aspects of the present invention. Also, common but well-understood elements that are useful or necessary in a commercially feasible embodiment are often not depicted in order to facilitate a less obstructed view of these various aspects of the present invention. Furthermore, it will be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Because of safety regulations many of today's cars feature a Tire Pressure Monitoring System (“TPMS”), which measures or estimates the condition of the tires, such as the inflation pressure and temperature, and alert the operator about the tire condition.

Some vehicles, typically higher end ones, offer TPMS localization, that is an association between tire condition information and the respective location of the tire on the vehicle. Many TPMS localization equipped vehicles display the pressure value for each tire is on the instrument cluster or another display. Thus in those vehicles a tire in an abnormal condition, for example under-inflated, can be localized, for example, based on the indicated pressure values.

However, on lower end vehicles and vehicles without the aforementioned displays often only a TPMS tell-tale indicator is set to warn the operator in case of abnormal tire condition. However, if the tell-tale is only a typical lighted icon on the instrument cluster, the tell-tale only indicates that at least one tire on the vehicle experiences an abnormal condition. The typical tell-tale does not indicate tires or tires experience the abnormal condition. It is up to the operator to check potentially all of the tires of the vehicle to determine which ones are affected. Accordingly, an approach of informing the operator of the location of the abnormal tire condition, other than adding a relatively expensive display, is desirable.

There are two popular general approaches to TPMS, indirect and direct TPMS. In indirect TPMS the condition of the tire is usually estimated using the dynamic performance of the tire, for example, the number of revolutions of a tire in relation to the other tires, the number of revolutions of a tire in relation to the estimated or measured land speed of the vehicle, or otherwise. Since the tire related data is usually collected from sensors in a permanent relationship to a particular wheel position (e.g. driver's side front, passenger's side front) the tire related data is already associated with a particular wheel position. However, in direct TPMS, the direct TPMS sensors are usually associated with a particular wheel rather than a wheel position. Moreover, it is typically rather easy to move direct TPMS sensors between wheels or replace them altogether, for example when tires are being serviced or replaced. Consequently, direct TPMS sensors are considered mobile with respect to the wheel positions and additional steps are taken to associate the direct TPMS sensors with a given vehicle or a wheel position.

While a number of vehicles autolearn which direct TPMS sensors are installed on the vehicle, for example by statistically analyzing the TPMS sensor identifiers reported to the vehicle over time, many vehicles require a learn procedure to be followed to indicate to the vehicle which direct TPMS sensors are in use of the vehicle. If the autolearn feature already localizes the direct TPMS sensors or can be cost effectively made to do so, or if the learn procedure is correctly followed and the direct TPMS sensors are not rotated without re-learning or otherwise indicating to the vehicle how the locations of the direct TPMS sensors have changed, even a lower end vehicle already remembers or can remember which sensor is in the respective location. Tire condition information from each TPMS sensor then relates to the tire at the location of the TPMS sensor. Thus, as long as the position of identifiers of the sensors on the vehicle are correctly learned and current, based on the learned identifiers the operator can receive an indication of the location of the abnormal tire condition provided that a facility exist to communicate that information to the operator.

To better facilitate the learn procedure some vehicles use turn signals to indicate the next wheel location in sequence that should be learned to the vehicle or that learning of a given wheel location was completed.

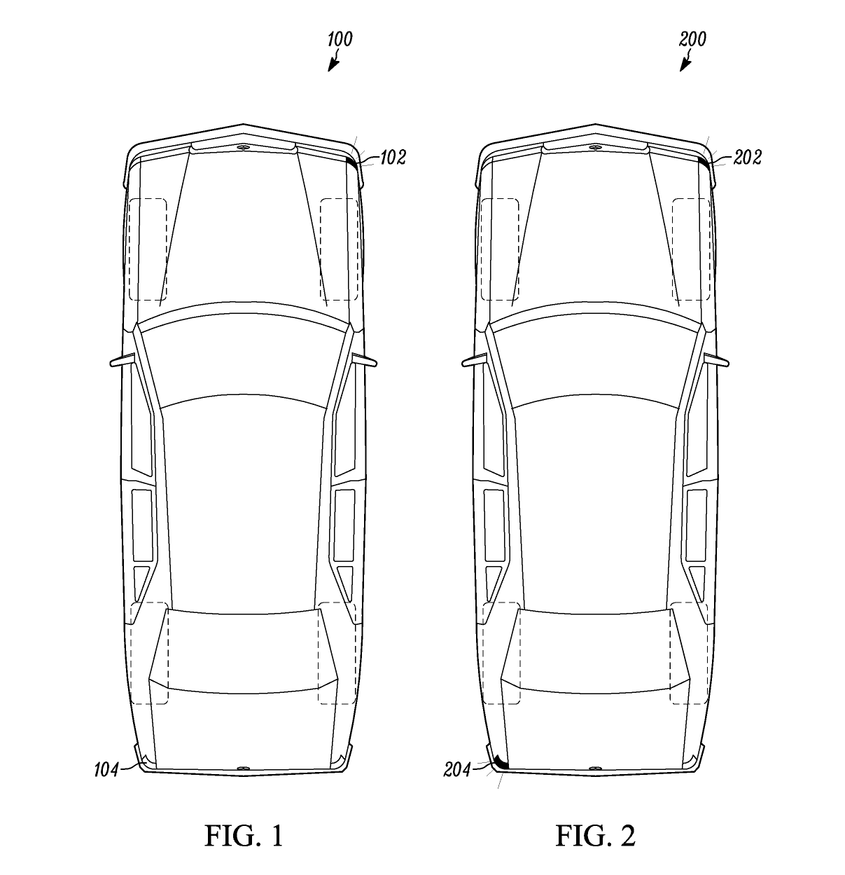

Accordingly, in an aspect the vehicle's already present turn signals are used to indicate an abnormal condition of a tire, similarly to how they are used during the learn procedure. For example, with reference to FIG. 1 when the under-inflation TPMS tell-tale is set, the vehicle 100 is not in motion, and the ignition is in the ACCESSORY position, the ON position, or when fault location indication is otherwise activated, for example using a Driver Information Center (“DIC”) button, the vehicle turns the turn signal indicator 102 corresponding to the under-inflated tire solid or according to another suitable pattern for a predetermined amount of time or until the fault is corrected. Moreover, with reference to FIG. 2 if the vehicle 200 has more than one under-inflated tire, the vehicle turns on the equivalent number of turn signal indicators 202, 204 respective to the positions where the fault occurred, either all at once or in a predetermined sequence. Hence, the operator can determine which tire to re-inflate or troubleshoot by inspecting the vehicle's turn signals and without the need for an additional display. In an example, with reference to FIG. 2 in contrast to FIG. 1 the turn signal turning off 204, 104 in response to inflation indicates that the tire has reached the correct pressure. In an example, an additional audible signal is used to draw the operator's attention to the change in the condition of a tire to normal.

In an aspect a fault location indication system implements the following method. Determine at least one of whether abnormal tire condition is occurring, whether the TPMS tell-tale is set, and whether the TPMS tell-tale should be set. Determine whether the vehicle is not in motion. Determine at least one of whether the ignition is in ACCESSORY position, the ON position, and whether a DIC button to activate fault location indication was actuated. Determine the location of a tire or tires in the abnormal condition. Activate the location indicator respective to each tire in the abnormal condition. Wait for the tire condition of at least one tire to change to normal condition. In response to the change to normal condition deactivate the location indicator respective to the tire which switched conditions from abnormal to normal. If one or more tires continue to be in an abnormal condition go back to waiting for the tire condition of at least one tire to change to normal condition until all tires are in the normal condition.

In an aspect a computer system comprising one or more processors executes program instructions for indicating the location of a tire in an abnormal condition using the vehicle's turn signals causing the one or more processors to carry out the steps of the method. In an example the instructions are stored in a non-transitory computer readable medium.

Those skilled in the art will recognize that a wide variety of modifications, alterations, and combinations can be made with respect to the described embodiments without departing from the spirit and scope of the invention, and that such modifications, alterations, and combinations are to be viewed as being within the scope of the invention. Further, those skilled in the art will recognize that the approaches described herein may also be used to design components and devices other than those listed above.

1. A method of indicating a location of at least one tire in an abnormal condition comprising:
determining whether the at least one tire is in the abnormal condition;
determining the location of the at least one tire in the abnormal condition;
indicating the location of the at least one tire in the abnormal condition using at least one vehicle turn signal.

2. (canceled)

3. (canceled)

4. (canceled)

5. (canceled)

6. (canceled)

7. (canceled)

8. (canceled)

9. A non-transitory computer readable medium containing program instructions for indicating a location of at least one tire in an abnormal condition using at least one vehicle turn signal, wherein execution of the program instructions by one or more processors of a computer system causes the one or more processors to carry out the steps of:
determining whether the at least one tire is in the abnormal condition;
determining the location of the at least one tire in the abnormal condition;
actuating the at least one vehicle turn signal to indicate the location of the tire in the abnormal condition.

10. The non-transitory computer readable medium as described in claim 9 wherein the abnormal condition comprises under-inflation.

11. The non-transitory computer readable medium as described in claim 9 wherein the abnormal condition comprises high temperature.

12. The non-transitory computer readable medium as described in claim 9 wherein the indicating comprises turning on the at least one vehicle turn signal.

13. The non-transitory computer readable medium as described in claim 9 wherein the indicating comprises keeping the at least one vehicle turn signal on while the at least one tire is in the abnormal condition.

14. The non-transitory computer readable medium as described in claim 9 wherein the indicating comprises flashing a pattern indicating a type of the abnormal condition.

15. The non-transitory computer readable medium as described in claim 9 wherein the at least one vehicle turn signal is proximate to the tire in the abnormal condition.

16. The non-transitory computer readable medium as described in claim 9 wherein the execution of the program instructions by one or more processors of a computer system causes the one or more processors to carry out the further step of actuating the at least one vehicle turn signal off when the tire is brought to a normal condition.

17. A system for indicating a location of at least one tire in an abnormal condition, the system comprising:
one or more processors configured to execute program instructions for indicating the location of the at least one tire in the abnormal condition using at least one vehicle turn signal; and
a non-transitory computer readable medium containing program instructions for indicating the location of the at least one tire in the abnormal condition using the at least one vehicle turn signal, wherein execution of the program instructions by the one or more processors causes the one or more processors to carry out the steps of:
determining whether at least one tire is in the abnormal condition;
determining the location of the at least one tire in the abnormal condition;
actuating the at least one vehicle turn signal to indicate the location of the at least one tire in the abnormal condition;
the one or more processors communicatively coupled to the non-transitory computer readable medium.

18. The system as described in claim 17 further comprising the at least one vehicle turn signal communicatively coupled to the one or more processors.

19. The system as described in claim 18 wherein the abnormal condition comprises under-inflation.

20. The system as described in claim 17 wherein the abnormal condition comprises under-inflation.

21. The method of indicating the location of the at least one tire in the abnormal condition as described in claim 1 wherein the abnormal condition comprises under-inflation.

22. The method of indicating the location of the at least one tire in the abnormal condition as described in claim 1 wherein the abnormal condition comprises high temperature.

23. The method of indicating the location of the at least one tire in the abnormal condition as described in claim 1 wherein the indicating comprises turning on the at least one vehicle turn signal.

24. The method of indicating the location of the at least one tire in the abnormal condition as described in claim 1 wherein the indicating comprises keeping the at least one vehicle turn signal on while the tire is in the abnormal condition.

25. The method of indicating the location of the at least one tire in the abnormal condition as described in claim 1 wherein the indicating comprises flashing a pattern indicating a type of the abnormal condition.

26. The method of indicating the location of the at least one tire in the abnormal condition as described in claim 1 wherein the at least one vehicle turn signal is proximate to the at least one tire in the abnormal condition.

27. The method of indicating the location of the at least one tire in the abnormal condition as described in claim 1 further comprising turning the at least one vehicle turn signal off when the at least one tire is brought to normal condition.
